(19) United States
(12) Patent Application Publication
(10) Pub. No.: US 2003/0169495 A1
(43) Pub. Date: Sep. 11, 2003

(54) Reflective light diffuser

(76) Inventor: Robin J. T. Clabburn, Wiltshire (GB)

Correspondence Address: Kent E Baldauf Sr, 700 Koppers Building, 436 Seventh Avenue, Pittsburgh, PA, 15219-1818, US

(21) Appl. No.: 10/275,083

(22) PCT Filed: May 3, 2001
(86) PCT No.: PCT/GB01/01938

(30) Foreign Application Priority Data
May 3, 2000 (GB) 0010697.1

(51) Int. Cl. G03B 21/56

(52) U.S. Cl. 359/443

(57) ABSTRACT

A reflective diffuser of light in one embodiment comprises an extruded, drawn, rolled or otherwise stretched or extended sheet comprising a matrix of a first plastics material incorporating inclusions of a second, different material, substantially insoluble in the first material, resulting in small scale surface irregularities on at least one surface of the sheet. The textured surface having such irregularities is rendered reflective or partly reflective, for example by metallisation, eg. by vapour deposition or other particle deposition of metal, such as vacuum sputtering. By controlling the extent to which the sheet is stretched preferentially in one direction during manufacture, the extent to which the diffuser has asymmetric diffusing properties can be readily controlled. Instead of metallising the extended sheet itself, the textured surface of the latter may be used as a mould or die surface for the production of a textured surface on another, eg. plastics sheet which may then be metallised or the textured surface of the extended sheet may be used as the progenitor of a mould or die surface for the production of such plastics sheets bound for metallisation to form reflective diffusers. Reflective light diffusers according to the invention may be used, for example, in LCD displays as back reflectors.

This invention relates to a reflective light diffuser, such as may be used as a front projection screen or, in an LCD display, as a diffusive reflector behind the liquid crystal cell.

It is an object of the invention to provide an improved reflective diffuser which is nevertheless relatively inexpensive to manufacture.

According to the invention, there is provided a reflective diffuser comprising an extruded, drawn, rolled or otherwise stretched or extended sheet comprising a matrix of a first plastics material incorporating inclusions of a second, different material, substantially insoluble in the first material, resulting in small scale surface irregularities on at least one surface of the sheet, said surface being rendered reflective or partly reflective, for example by metallisation, eg. by vapour deposition or other particle deposition of metal, such as vacuum sputtering.

According to another aspect of the invention, there is provided a front projection system including a projector and a reflective light diffusing screen adapted to receive an image projected thereon by the projector, and wherein the screen is a light diffusing sheet in accordance with the first aspect of the invention and is arranged with its metallised, or otherwise reflective side facing the projector.

According to yet another aspect of the invention, there is provided an LCD display comprising a liquid crystal cell and, disposed behind the cell, a reflective light diffusing screen in accordance with the first aspect of the invention which is arranged with its metallised, or otherwise reflective, side adjacent the liquid crystal cell.

According to a still further aspect of the invention, there is provided a method of manufacturing a reflective diffuser according to the first aspect of the invention, wherein the second material is also a plastics material, the method comprising compounding said first plastics material with the second material at a temperature at which at least said first plastics material is flowable or molten, and extruding, drawing or otherwise stretching or extending the resulting mixture whilst it is still flowable, to provide said sheet, and thereafter carrying out said step of rendering a surface of the sheet reflective or partly reflective.

In carrying out this method, the processing conditions (including such factors as “stretch ratio”, and processing temperatures), and the plastics materials are selected, taking account of the physical properties of the materials (such as viscosity, variation of viscosity with temperature, etc.,) so as to provide the screen characteristics desired, including any desired asymmetry in optical diffusion characteristics of the finished product.

A product suitable for metallisation to form an embodiment of the invention may also be produced by mixing pre-formed particles, such as short fibres, with a suitable matrix material, before extruding, drawing, or otherwise extending the resulting mixture to form the product for metallisation.

A product suitable for metallisation to form an embodiment of the invention may also be produced by a casting process, using an appropriate resin and particle combination.

The sheet before being rendered reflective may, by way of example, be formed by any of the methods described in EP-A-046449, EP-A-0800658, EP-A-0843203, EP-A-0627638, JP-A-5-113606, U.S. Pat. No. 5,307,205, U.S. Pat. No. 4,165,153, U.S. Pat. No. 4,983,016, or U.S. Pat. No. 5,473,454, which disclose techniques for manufacturing light transmitting diffusers comprising a matrix of a first plastics material incorporating discrete particles of another material.

Since the diffusing effect in reflection of the material in accordance with the present invention is due to a surface texturing, however, it will be understood that the embedded particles or islands need not be light transmitting nor indeed need the matrix material be.

The prior patent specifications noted above describe the formulation and processing of polymer materials to create light transmitting diffusers suitable as optical screen materials. These specifications describe symmetrically and asymmetrically diffusing optical screen materials. Asymmetry in diffusion is imparted typically by stretching to create orientation.

The applicants have found that such asymmetry is also a property of the reflective surface produced by, for example metallisation of a surface of such a screen material which has been stretched preferentially in one direction in the plane of the sheet material, suggesting that the stretching, in addition to elongating the particles of plastics in the matrix material, also produces corresponding elongation of the surface protuberances or bulges which are, it is believed, formed over embedded particles lying close to the respective surface of the sheet material.

Embodiments of the invention are described below by reference to the accompanying drawing, in which:—

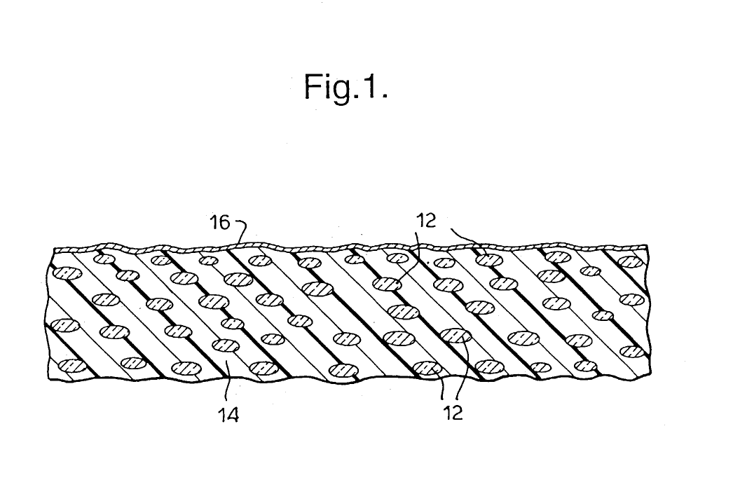

FIG. 1 is a schematic view, in cross section perpendicular to the plane of the sheet material, through a light diffusing reflective sheet or screen material embodying the invention.

Referring to FIG. 1, a light-diffusing material embodying the invention comprises a primary matrix 14 incorporating a quantity of discrete transparent bodies 12 embedded in the matrix 14. In preferred embodiments of the invention, the primary matrix material 14 and the bodies 12 are of plastics materials, preferably thermoplastics, the matrix 14 defining a plastics sheet or film of a thickness of, typically 0.12 mm, with the mean diameter of the bodies 12 being, for example, of the order of 5 to 10 microns (m⁻⁶). In the preferred embodiment, the ratio, by volume, of the bodies 12 to the primary matrix 14 is about 1:5. It is contemplated that the particles 12 need not be of thermoplastics, but may be of other materials such as thermosetting resin, or glass, for example.

It will be appreciated that the structure described with reference to FIG. 1 may be achieved in several ways. For example, pre-formed solid bodies 12 of the desired size may be mixed with a molten thermoplastics polymer which is subsequently extruded, or extruded and blown, to form the sheet screen material, or respective quantities of incompatible thermoplastics materials may be compounded in a plasticised or molten state to break up the (molten) materials forming the minor proportions of the blend into discrete globules of the desired size, suspended in a continuous matrix formed by the molten major component, and the resulting material may be formed into a sheet or film by any of a variety of methods known per se. Whatever technique is used, it is necessary that, if the material of the bodies 12 is molten at the temperature at which the sheet is formed (see below), (or in the temperature range in which the sheet is formed), the viscosity of the material of bodies 12 is higher than that of the matrix material 14 at that temperature or over that temperature range.

In the preferred embodiments, in which the bodies 12 are formed from thermoplastics incompatible with the thermoplastics matrix material 14 and the compounded mixture, in a molten or plasticised state, is formed into a thin film by a process in which a smaller diameter tube formed by extrusion is inflated under internal pressure and whilst still in plastically deformable state to a larger tube and the inflated tube is drawn off (hauled off) mechanically (and, for example, rolled up) all by a process similar to that conventionally used in the manufacture of plastic bags, the extrusion and hauling-off tend to stretch the matrix 14 and the bodies 12 in the direction of longitudinal extrusion, whilst the blowing tends also to stretch the matrix 14 and the bodies 12 circumferentially in the circumferential direction of the tube. Preferential elongation of the bodies 12 in one direction in the “plane” of the sheet material renders the light diffusing properties of the material asymmetric, that is to say the material diffuses light through a narrower angle in a plane perpendicular to the sheet material and parallel with the preferred direction of elongation than in a plane perpendicular to the sheet material and to the direction of elongation. By controlling the draw-off rate relative to the extrusion and inflation rates, this asymmetry can be controlled or neutralised to produce a light diffusing material having a controlled degree of, or no, diffusive asymmetry. Since, with the production method described, a screen material having no diffusive asymmetry is one in which each body 12 has, in principle, been stretched equally in all directions in the plane of the sheet, it will be appreciated that in such a material the shapes of the bodies may range from oblate spheroids to circular lenticular or disc-like bodies. The viscosity difference between the matrix material 14 and the material of the particle 12, and/or (possibly) the difference in surface energy of these materials, results in the surfaces of the sheet material being textured, on a microscopic scale, rather than perfectly smooth and glossy, the texturing taking the form of a mass of domed regions each, it is hypothesised, overlying a respective body 12 close to the surface. The applicants infer that preferential stretching in one direction in the “plane” of the sheet, (i.e. stretching more in one such direction than another) elongates these domed regions, as well as the bodies 12 in the direction of preferential stretching and that this is responsible for the observed asymmetry in reflective diffusion (see below).

After manufacture of the sheet material described, it is rendered reflective by depositing on one surface, a metallisation, indicated at 16, applied by a known metallic particle deposition technique, such as a vapour deposition technique or a vacuum sputtering technique. It will be understood that whilst FIG. 1 shows the metallisation layer as being of perceptible thickness, the layer is in practice very thin, perhaps even mono-molecular, and as a result the texturing of the underlying surface of the plastics sheet is accurately reproduced in the light reflective metallisation layer. At all events, if a beam of light is directed onto the reflective metallised surface, from the side of the sheet on which the metallisation lies, (i.e. so that the light beam does not have to pass through the matrix 14 or bodies 12) the light is reflected diffusely and, where the sheet has been stretched more in one direction in its “plane” than in others, the diffusion characteristics are asymmetric, i.e. the light is spread more in one plane perpendicular to the plane of the sheet than in an orthogonal plane also perpendicular to the plane of the sheet.

Examples of manufacture of an optically diffusing reflective screen by the technique described above are described in more detail below:—

### EXAMPLE 1

In the following example, an extrudable thermoplastics compound was produced by mixing the component polymers in a compounding extruder fitted with a cavity transfer mixer. The compound was then extruded into a thin film using a conventional extrusion line incorporating film blowing equipment. The process temperature was 180° C. The extrusion die had a diameter of 180 mm with a (radial) die gap of 1.2 mm and the extruded material was blown to a diameter of either 400 mm enabling the production of a continuous film 0.12 mm thick (by flattening the blown tube and slitting or trimming along opposite longitudinal edges of the flattened tube), of a width of approximately 24 inches (600 mm). The reduction in thickness of 10:1 comes from the ratio of bubble to die diameter (about 3:1) and haul-off rate. Bubble ratios in excess of 5:1 can be achieved. The haul-off rate controls the symmetry or degree of asymmetry in diffusion (for a given bubble ratio). For symmetric materials the haul-off rate and the extrusion rate should be very similar for the exemplified approx. 10:1 thickness reduction.

The matrix (14) material may, for example, be ethylene/ethyl acrylate copolymer resin, LE 5861 (available from Borealis/Distrupol) whilst the material to form the bodies 12 may be polystyrene resin, such as N1910, (available from Victor Plastics). The ethylene/ethyl acrylate copolymer resin and the polystyrene resin may be blended in the ratio 75:15 to 85:15. As the ethylene/ethyl acrylate copolymer resin and the polystyrene resin are incompatible (i.e. each is substantially insoluble in the other), the compounding process results in a quasi emulsion or dispersion of minute droplets of molten polystyrene resin in the molten acrylate copolymer resin.

The sheet material produced as described is then rendered reflective on one side, for example by a known metallic particle deposition technique, for example by vapour deposition or by vacuum sputtering.

### EXAMPLE 2

Material as described in Example 1 but with a mix ratio of 85:15 was extruded into films of various thickness and with various degrees of orientation. The optical properties and thickness of these films were measured and recorded. The films were then metallised (vacuum deposited aluminium) and the optical properties of the reflecting surface recorded.

The results are tabulated as follows:

TABLE 1
Before metallising

| Trials | Thickness | AOV | Asymmetry ratio |
|---|---|---|---|
| 1 | 62 μm | 34° × 11° | 3.1 |
| 2 | 89 μm | 54° × 25° | 2.16 |
| 3 | 122 μm | 68° × 64° | 1.06 |

TABLE 2
After metallising

| Trial | AOV | Asymmetry Ratio |
|---|---|---|
| 1 | 30° × 17° | 1.76 |
| 2 | 25° × 18° | 1.4 |
| 3 | 22° × 21° | 1.05 |

Since the formulation is constant, the angle of view (AOV) for material in transmission as recorded in Table 1 is related to thickness and to the extent the material is oriented during processing. However in Table 2 where measurements are taken in reflection (from the metallised surface) the optical properties are now related to the formulation, orientation during processing but the film thickness has little effect.

These results demonstrate that the optical properties of a surface in reflection can be achieved by controlling the formulation and processing of an appropriate substrate material.

It will be noted that the asymmetry ratio for the metallised material differs slightly from that of the material in transmission. It is believed this is due to the effective asymmetry of the particles being reduced by the “overcoating” with the matrix material.

In the tables above, “AOV” signifies “angle of view” which, in the context where the sheet material is illuminated by a beam of parallel (collimated) light incident normal to the plane of the sheet material, is the angle, with respect to such normal, at which the perceived brightness of the light reflected diffusely falls to one half of the corresponding perceived brightness on said normal. For asymmetric diffusers, the “AOV” is greater in one plane containing such normal than in a perpendicular plane. In the above tables, the two figures in each row of the “AOV” column are respectively the angle of view in a plane containing the normal and which is perpendicular to the direction of orientation or stretching of the material and the angle of view in a plane containing the normal but parallel with said direction of orientation (this being the smaller “AOV” figure).

In embodiments of the invention, where the sheet or screen is to be used purely as a reflective diffuser, with the metallised side of the screen facing the light source, there is, of course, no necessity for the matrix 14 or bodies 12 to be light-transmitting. However, if the matrix 14 and bodies 12 are of transparent plastics materials of different refractive indices, the combination of the matrix 14 and bodies 12 will itself have bulk light diffusing properties for light passing through the matrix 14 and bodies 12, so that without the metallisation the sheet material can be used as an effective light-diffusing screen, for example as a rear projection screen. The bulk light-diffusing properties of the combination of matrix 14 and bodies 12 means that the product, rendered reflective on one side as described, may be used as a reflective light diffuser for light directed at the sheet from its non-metallised side (and thus passing through the matrix 14 and bodies 12 to reach the metallised surface and being reflected back therefrom through the matrix 14 and bodies 12 again). Furthermore, if the metallisation 16 is so thin as to be partly light reflective and partly light-transmitting (i.e. “transflective”) it will have different diffusing characteristics in transmission than in reflection. Such a sheet or screen may have application, in for example, LCD displays which are intended to be viewable in reflected ambient light, where available, or by a back-lighting arrangement, the partly reflective, partly light-transmitting screen being in such a case interposed between the liquid crystal cell and the back-lighting arrangement.

In general, whereas the diffusing characteristics for light passing through the matrix 14/bodies 12 combination will depend on the thickness of that combination, the diffusing characteristics for light directed onto the metallised surface from a source on the opposite side of the metallisation 16 remote from the matrix 14 is independent of the thickness of the matrix layer.

In accordance with the invention a substrate providing a relief surface suitable for metallisation to provide a reflective diffuser may also be produced in other ways, for example a solvent-based lacquer may be mixed with particles or inclusions and allowed to dry by evaporation of the solvent so that the lacquer matrix will shrink as it dries—yielding a product similar to that underlying the metallisation in the drawing.

It is also contemplated, within the invention, to use the textured, unmetallised surface of a substrate provided by any of the means discussed above as a die, mould, or impressing tool by which the textured surface may be replicated in a suitable material. For example, a photo-curable, or heat curable resin may be brought or pressed into intimate contact with the textured surface of the substrate, cured and then stripped from the substrate after which the replicate textured surface of the cured resin may be metallised as described above to yield a diffusive reflector. In some cases, a mould or press die for the production of a textured surface to be metallised to form a reflective diffuser may itself have a replicate surface produced by moulding against such a textured substrate, in the manner described above. Such a technique makes it possible to provide ready volume production of reflective diffusers of controlled asymmetry, by a relatively straightforward embossing, impressing or moulding process, the control of asymmetry being achieved during the production of the substrate comprising the matrix of the first plastics material incorporating inclusions of the second, different material, for example by controlling the stretch of such substrate, as described above.

In the present specification “comprises” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A reflective diffuser comprising an extruded, drawn, rolled or otherwise stretched or extended sheet comprising a matrix of a first plastics material incorporating inclusions of a second, different material, substantially insoluble in the first material, resulting in small scale surface irregularities on at least one surface of the sheet, said surface being rendered reflective or partly reflective, for example by metallisation, eg. by vapour deposition or other particle deposition of metal, such as vacuum sputtering.

2. A front projection system including a projector and a reflective light diffusing screen adapted to receive an image projected thereon by the projector, and wherein the screen is a light diffusing sheet in accordance with claim 1 and is arranged with its metallised, or otherwise reflective side facing the projector.

3. An LCD display comprising a liquid crystal cell and, disposed behind the cell, a reflective light diffusing screen in accordance with claim 1 which is arranged with its metallised, or otherwise reflective, side adjacent the liquid crystal cell.

4. A method of manufacturing a reflective diffuser according to claim 1, wherein the second material is also a plastics material, the method comprising compounding said first plastics material with the second material at a temperature at which at least said first plastics material is flowable or molten, and extruding, drawing or otherwise stretching or extending the resulting mixture whilst it is still flowable, to provide said sheet, and thereafter carrying out said step of rendering a surface of the sheet reflective or partly reflective. thereafter carrying out said step of rendering a surface of the sheet reflective or partly reflective.

5. A reflective diffuser comprising a first textured surface which has been produced directly or indirectly by a moulding, impressing or embossing step from a surface of an extruded, drawn, rolled or otherwise stretched or extended sheet comprising a matrix of a first plastics material incorporating inclusions of a second, different material, substantially insoluble in the first material, resulting in small scale surface irregularities on at least one surface of the sheet, said first surface being rendered reflective or partly reflective, for example by metallisation, eg. by vapour deposition or other particle deposition of metal, such as vacuum sputtering.

6. A reflective diffuser substantially as hereinbefore described with reference to Examples 1 and 2 herein.

7. A method of making a reflective diffuser, substantially as hereinbefore described with reference to Examples 1 and 2 herein.
